(19) United States
(12) Patent Application Publication
(10) Pub. No.: US 2006/0214342 A1
(43) Pub. Date: Sep. 28, 2006

(54) Apparatus and method for holding in position adjacent facing ends of tube sections for joining them by welding

(75) Inventor: Daniel Girard, St-Felicien (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Vidal Construction Inc., Montreal, Quebec (CA)

(21) Appl. No.: 10/522,584

(22) PCT Filed: Jun. 30, 2003
(86) PCT No.: PCT/CA03/00991

§ 371 Date: Mar. 3, 2006

(30) Foreign Application Priority Data
Jul. 29, 2002 (CA) 2,396,176

(51) Int. Cl. B25B 1/20

(52) U.S. Cl. 269/43

(57) ABSTRACT

The present invention is concerned with an apparatus (2) and a method, for holding in position adjacent facing ends of tube sections for preferably joining them by welding. The apparatus has an elongated element (8) insertable between the adjacent facing ends, first and second jaw devices (10, 12) movable with respect to each other along the elongated element (8) and each (10, 12) having a contact portion (14) for contacting the tube portions, and clamping means (62) for clamping the tube sections with the jaw devices (10, 12) to hold in position the facing ends.

### FIELD OF THE INVENTION

The present invention relates to an apparatus and a method for holding in position adjacent facing ends of tube sections. More specifically, the present invention relates to the use of such an apparatus in the field of tube welding.

### BACKGROUND OF THE INVENTION

There exist in the prior art several documents describing different types of apparatuses for holding in position adjacent facing ends of tube sections, in order to for instance, connecting them by welding.

It is generally known that prior to welding ends of tube or pipe to one another, it is necessary that the ends of the tube be properly positioned or aligned to one another for providing an adequate weld.

Already known in the art, there are apparatuses or tools for clamping and aligning adjacent ends of tubes for connecting them by welding. Examples of these prior art apparatuses are disclosed in U.S. Pat. Nos. 4,195,828; 4,579,272; 4,722,468; 4,750,662; 5,052,608; 6,325,277 and 6,349,869. These prior art apparatuses are effective when there is only one tube to work on or there is no space constraint between tubes to repair or weld. In boiler wall tubes for example, the boiler tubes are positioned in closely spaced relation thus making it very difficult nor impossible to use the above mentioned prior art devices. However, there are devices that are adapted for use with boiler tubes forming a boiler wall, such as those described in U.S. Pat. Nos. 4,846,391 and 4,936,500. Yet, these apparatuses are useful when the boiler tubes are interconnected by a web. More specifically, to make use of these apparatuses, it seems necessary to form slots in the web between adjacent tubes.

While the apparatuses known in the art have resulted in the advancement within the present field and especially the one described in U.S. Pat. No. 4,936,500, most if not all of these prior art apparatuses are not efficient if the tubes are too closely spaced apart.

Therefore, there is still a need for new and improved apparatus and method for holding in position adjacent facing ends of tube sections even if there is a very limited space for mounting the apparatus or operating the method.

### SUMMARY OF THE INVENTION

It is therefore an object of the present invention to provide apparatus and method for holding in position adjacent facing ends of tube sections that will fulfil the above mentioned need.

In accordance with the invention, there is provided an apparatus for holding in position adjacent facing ends of tube sections aligned along an axis, comprising:
an elongated element insertable between the adjacent facing ends;
first and second jaw devices movable with respect to each other along the elongated element and each having a contact portion for contacting the tube portions, at least one of the jaw devices being removable from the elongated element; and
clamping means for clamping the tube sections with the jaw devices to hold in position the facing ends.

The present invention also provides a method for holding in position adjacent facing ends of tube sections aligned along an axis, said method comprising the steps of:
a) inserting an elongated element between the adjacent facing ends;
b) placing first and second jaw devices on both sides of the tube sections for cooperatively engaging the jaw devices on opposite end portions of the elongated element; and
c) clamping the tube sections with the jaw devices to hold in position the facing ends.

The objects, advantages and other features of the present invention will become more apparent upon reading of the following non-restrictive description of the preferred embodiments thereof, given for the purpose of exemplification only with reference to the accompanying drawings.

### BRIEF DESCRIPTION OF THE DRAWINGS

FIG. 1 is a perspective view of an apparatus in an assembled position, according to a preferred embodiment of the invention.

FIG. 2 is a side view partially in cross section of the apparatus of FIG. 1, in a dismantled position.

FIG. 3 is a perspective view of an element of the apparatus of FIG. 1.

FIG. 4 is a cross section view along line 4-4 of FIG. 1.

FIG. 5 is a cross section view along line 5-5 of FIG. 3, in relation with an element of the apparatus, shown in FIG. 4, in another operating position.

FIG. 6 is a side view of the apparatus of FIG. 1, in relation with adjacent ends of tube sections.

FIG. 7 is a top view of what is shown in FIG. 6, in relation to neighbouring tubes.

### DESCRIPTION OF A PREFERRED EMBODIMENT

In the following description, the same numerical references refer to similar elements. It will be also understood that the embodiments shown in the figures are preferred.

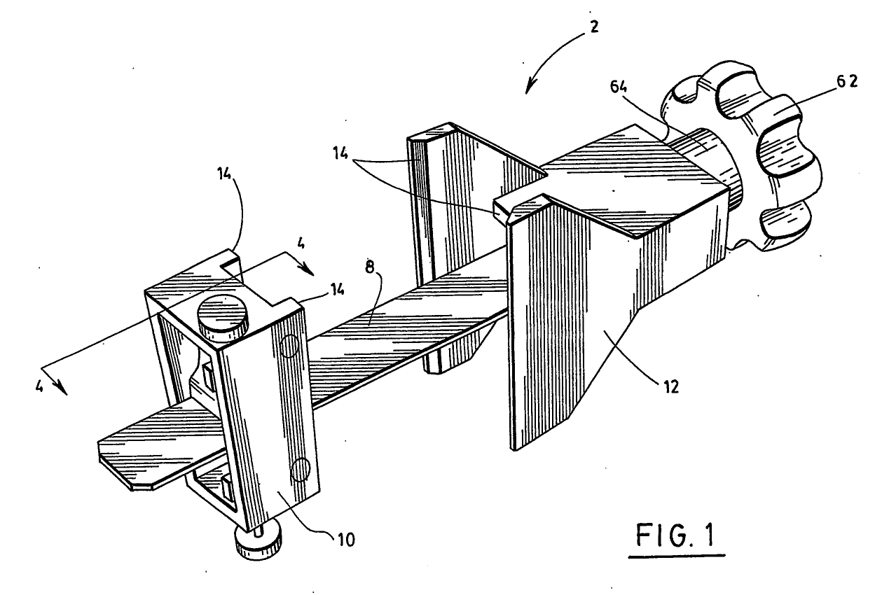

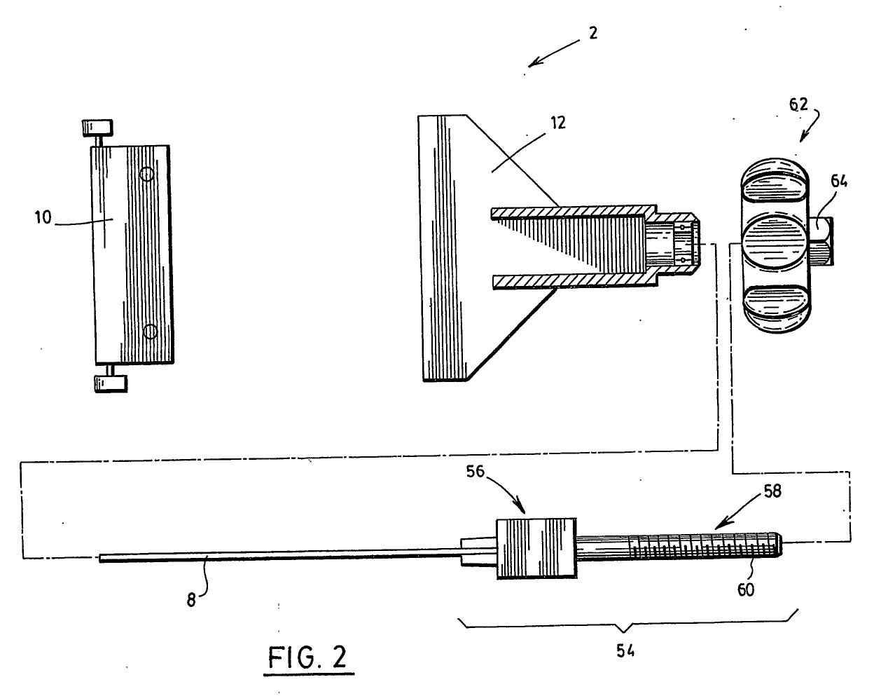

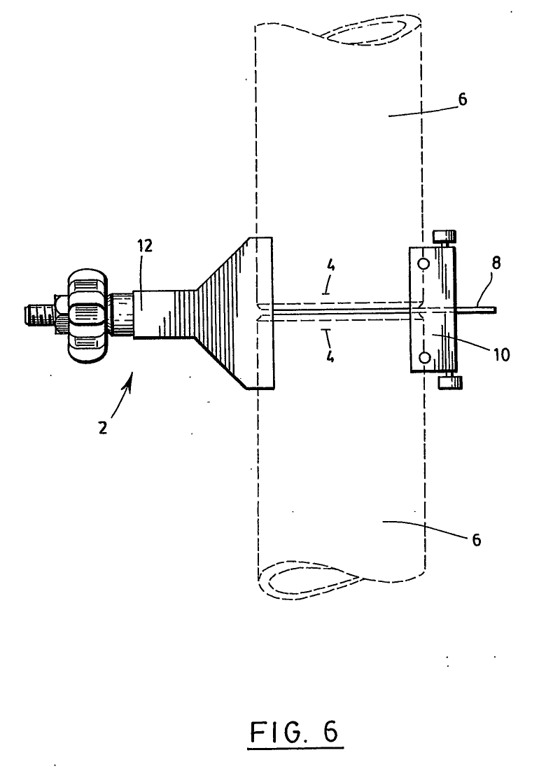

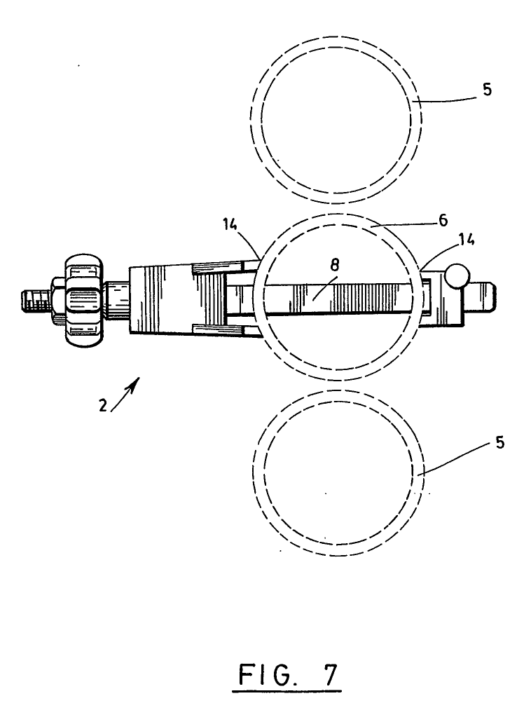

By viewing FIGS. 1 and 2 in conjunction with FIGS. 6 and 7, one can see views of an apparatus 2 for holding in position adjacent facing ends 4 of tube sections 6 aligned along an axis. The apparatus 2 comprises an elongated element 8 insertable between the adjacent facing ends 4. The apparatus 2 of the invention also comprises first and second jaw devices 10, 12 that are movable with respect to each other along the elongated element 8. Each of the jaw devices have a contact portion 14 for contacting the tube portions 6, and at least one of the jaw devices, and particularly the first one 10, is removable from the elongated element 8. Furthermore, the apparatus 2 comprises clamping means for clamping the tube sections 6 with the jaw devices 10, 12 to hold in position the facing ends 4.

Preferably, as can be seen in FIG. 2, both jaw devices are removable from the elongated element 8. Please note that in FIG. 7, there are shown neighboring tubes 5 which limit the space where the apparatus can be mounted.

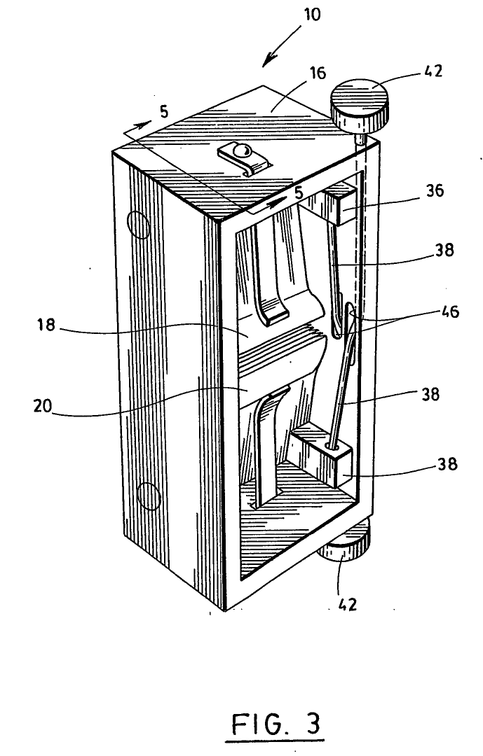

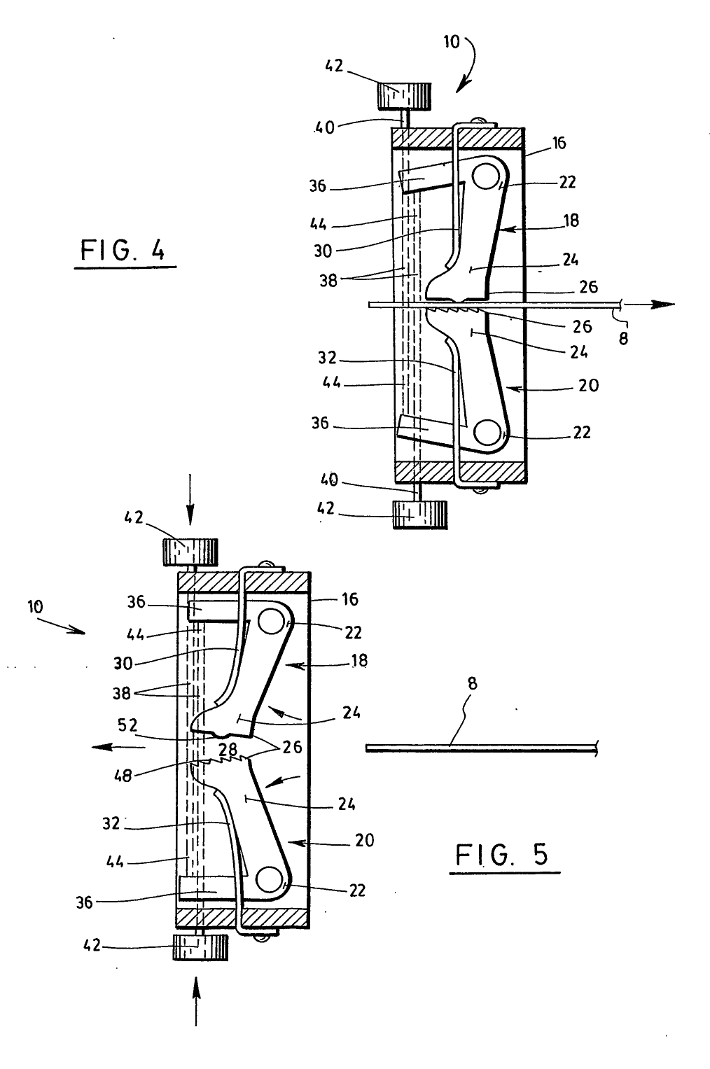

Referring to FIGS. 3 to 5, there is shown a preferred embodiment wherein the first jaw device 10 comprises a frame 16, and first and second members 18, 20. FIGS. 4 and 5 better show that each of the members has a first end 22 pivotally connected to the frame 16 and a second end 24 opposite the first end 22. The second end 24 has edges 26 pivotable between a first position where a passage 28 is defined between the edges 26 for introducing therein the elongated element 8 (see FIG. 5), and a second position where the passage 28 is reduced for restraining the elongated element 8 (see FIG. 4). The first jaw device 10 also comprises means for urging the members 18, 20 in the second position and means for manually urging the members 18, 20 in the first position.

The means for urging the members 18, 20 in the second position preferably comprise first and second resilient elements 30, 32 respectively biasing the first and second members 18, 20 in the second position where a point of support is taken on the frame 16. The means for manually urging the members 18, 20 in the first position comprise two urging devices 34. Each of the urging devices 34 include a lever arm 36 mounted on the first end 22 of the corresponding member, a rod 38 having a first end 40 provided with a handle 42, and a second end 44 for contact against the lever arm 36. As best viewed in FIG. 3, the urging device further includes a guide 46 integrated in the frame 16 for guiding the rod 38 from a location where the handle 42 is accessible to the lever arm 36.

Preferably, the second end 24 of the first member 18 has a serrated surface 48 and the second end 24 of the second member 20 has a surface 50 with a longitudinal ridge 52. These features particularly help to better grip the elongated element 8 between the second end 24 of the members 18, 20. It will be further understood that although the present invention prefers using a device wherein the second ends are provided with the above mentioned features, it also contemplates employing a device wherein the second ends are both provided with a serrated surface.

Referring back to FIG. 2, one can see that according to a preferred embodiment, the clamping means comprises a shaft 54 having a first end 56 solid with the elongated element 8, and a second end 58 opposite to the first end 56. The second end 58 comprises a threaded end section 10 extending through the second jaw device 12, and a threaded element 62, such as a knob provided with a threaded bore, for threadably engaging with the threaded end section 60. The threaded element 62 has a stop portion 64 for contact against the second jaw device 12 to, in operation, move the jaw devices 10, 12 towards each other and clamp therebetween the tube sections 6. It will be understood that although the present invention prefers using a knob 62 for threadably engage with the threaded end section 60, any other element that fulfil the role of the knob, for instance a nut, is contemplated by the present invention.

Referring now to FIGS. 1 to 7, according to the present invention, there is also provided a method for holding in position adjacent facing ends 4 of tube sections 6 aligned along an axis, said method comprising the steps of:
a) inserting an elongated element 8 between the adjacent facing ends 4;
b) placing first and second jaw devices 10, 12 on both sides of the tube sections 6 for cooperatively engaging the jaw devices 10, 12 on opposite end portions of the elongated element 8; and
c) clamping the tube sections 6 with the jaw devices 10, 12 to hold in position the facing ends 4.

It will be understood, that step a) is preferably performed before step b). However, it will be also understood that some minor modification in the steps of the method of the invention can be effected without departing from the scope of the invention. For instance, one can engage a jaw device on one end of the elongated element 8, then insert the elongated element 8 between the adjacent facing ends 4, and thereafter engage the other jaw device on the remaining free end of the elongated element 8.

As mentioned previously, the apparatus 2 and the method of the present invention are particularly useful in the field of welding and more specifically for use in holding boiler tube sections in an aligned relation to enable the ends of the boiler tubes to be joined by welding. In such a situation, it will be understood that the dimension of the elongated element 8 may vary according to the characteristics of the boiler tubes, for instance their diameter. Moreover, the thickness of the elongated element 8 can be advantageously modified in order to conform with specific welding standards. Indeed, the elongated element contemplated by the present invention preferably has a thickness of about ⅛ of an inch in order to performed adequate spot weld to the joint.

In use in the context of wall boiler tubes, the apparatus 2 of the present invention is preferably used by a pair of welders, one on either side of an array of boiler tubes 5, 6, as shown in FIG. 7. If a repair is being performed, the elongated element 8 is inserted by one of the welders between adjacent facing ends 4 of tube sections 6 to be joined together by welding. Then, each of the welders, having one of the jaw devices 10 and 12, engages his respective jaw device on the elongated element 8. Thereafter, the welder having the second jaw device 12, rotates the knob 62 to move the jaw devices 10, 12 towards each other and clamp therebetween the tube sections 6. The welders spot weld the joint in several circumferential spaced locations and thereafter remove the apparatus 2 before completion of the welded joint.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. An apparatus for holding in position adjacent facing ends of tube sections aligned along an axis, comprising:
an elongated element insertable between the adjacent facing ends;
first and second jaw devices movable with respect to each other along the elongated element and each having a contact portion for contacting the tube portions, at least one of the jaw devices being removable from the elongated element; and
clamping means for clamping the tube sections with the jaw devices to hold in position the facing ends.

2. The apparatus of claim 1, wherein the first jaw device comprises
a frame;
first and second members, each having a first end pivotally connected to the frame and a second end opposite the first end, said second end respectively having edges pivotable between a first position where a passage is defined between said edges for introducing therein the elongated element, and a second position where said passage is reduced for restraining the elongated element;
means for urging the members in the second position; and
means for manually urging the members in the first position.

3. The apparatus of claim 2, wherein the means for urging the members comprise first and second resilient elements respectively biasing said first and second members in the second position by taking a point of support in the frame.

4. The apparatus of claim 2, wherein the means for manually urging comprise two urging devices each including:
a lever arm mounted on the first end of the member;
a rod having a first end provided with a handle, and a second end for contact against the lever arm; and
a guide integrated in the frame for guiding the rod from a location where the handle is accessible to the lever arm.

5. The apparatus of claim 2, wherein the second end of the first member has a serrated surface and wherein the second end of the second member has a surface with a longitudinal ridge.

6. The apparatus of claim 1, wherein the clamping means comprises:
a shaft having a first end solid with the elongated element, and a second end opposite to the first end, the second end comprising a threaded end section extending through the second jaw device; and
a threaded element for threadably engaging with the threaded end section, said threaded element having a stop portion for contact against the second jaw device to, in operation, move the jaw devices towards each other and clamp therebetween the tube sections.

7. The apparatus of claim 1, wherein the threaded element is a knob provided with a threaded bore for threadedly receive the threaded end section.

8. A method for holding in position adjacent facing ends of tube sections aligned along an axis, said method comprising the steps of:
a) inserting an elongated element between the adjacent facing ends;
b) placing first and second jaw devices on both sides of the tube sections for cooperatively engaging the jaw devices on opposite end portions of the elongated element; and
c) clamping the tube sections with the jaw devices to hold in position the facing ends.

9. The method of claim 8, wherein step a) is performed before step b).
